(19) United States
(12) Patent Application Publication
(10) Pub. No.: US 2024/0421520 A1
(43) Pub. Date: Dec. 19, 2024

(54) CONNECTOR

(71) Applicant: Taicang Manaflex Technology Co., Ltd., Taicang City (CN)

(72) Inventors: Robert C. LANE, Las Vegas, NV (US); Yifei LIU, Toronto (CA); Xiaolou HUANG, Longueuil (CA)

(21) Appl. No.: 18/741,896

(22) Filed: Jun. 13, 2024

(30) Foreign Application Priority Data
Jun. 15, 2023 (CN) 202310709756.2

(51) Int. Cl. H01R 12/73; H01R 4/48; H01R 4/72; H01R 12/79; H01R 13/52; H01R 13/629

(52) U.S. Cl. CPC H01R 12/73; H01R 4/48; H01R 4/72; H01R 12/79; H01R 13/5202; H01R 13/629

(57) ABSTRACT

A connector which comprises a first circuit board and a connecting piece detachably connected to the first circuit board, the connecting piece comprises a second circuit board and a third circuit board, one end of the second circuit board is detachably connected to the first circuit board through a plug connector, and the other end of the second circuit board is detachably connected to the third circuit board through a plug connector. One end of the second circuit board is electrically connected with the first circuit board, the other end of the second circuit board is electrically connected with one end of the third circuit board, and the third circuit board is a flexible circuit board and is electrically connected to the first circuit board through the second circuit board. The connector disclosed by the invention is simple in structure, and convenient to disassemble and assemble the circuit boards.

### CROSS-REFERENCE TO RELATED APPLICATION

This application claims priority to and the benefit of Chinese Utility Model Application No. 202310709756.2, filed Jun. 15, 2023, the entire disclosure of which is incorporated by reference in its entirety.

### TECHNICAL FIELD

The present invention relates to the technical field of electrical connectors, and in particular to a connector.

### BACKGROUND TECHNOLOGY

Connectors are used for electrical connection between two circuit boards and other electronic components to realize current and/or signal transmission functions. The connector and the circuit board are connected by plug-in or welding; among them, the plug-in connection connector needs to correspond to the circuit board one-to-one, and the compatibility between different types of connectors and electronic components is poor, and the replacement cycle of electronic components is short, and the damage of a single electronic component may lead to the need to replace the components of the entire electrical circuit, resulting in increased costs and waste; and welded connectors cannot be disassembled and assembled after being fixedly connected, which is also not conducive to subsequent electronic components. Removal and replacement of components.

### SUMMARY

The object of the present invention is to provide a connector to overcome the deficiencies in the prior art.

In order to achieve the above objects, the present invention provides the following technical solutions:

An embodiment of the invention discloses a connector, which includes a first circuit board and a connector detachably connected to the first circuit board. The connector includes a second circuit board and a third circuit board. One end of the second circuit board is detachably connected to the first circuit board through a plug connector, and the other end is electrically connected to one end of the third circuit board. The third circuit board is a flexible circuit board, and the third circuit board is electrically connected to the first circuit board through the second circuit board.

Further, a plurality of first circuits are provided in the first circuit board, first soldering pads and second soldering pads are provided at both ends of the first circuit board, and a plurality of second circuits are provided in the second circuit board. The third soldering pads and fourth soldering pads are respectively provided at both ends of the second circuit, and a fifth soldering pad is provided at one end of the third circuit board close to the second circuit board, wherein the second soldering pad is electrically connected to the third pad, and the fourth pad is electrically connected to the fifth pad.

Further, the third circuit board includes a plurality of conductive lines and protective films laminated on both sides of the conductive lines. One end of the protective film close to the second circuit board is processed with avoidance holes corresponding to the conductive lines, which are exposed to the conductive lines in the escape holes form the fifth bonding pad.

Further, the conductive wire is made of metal.

Further, the conductive wire is made of copper or aluminum.

Further, a nickel layer is provided on a surface of the fifth bonding pad close to the fourth bonding pad, and the nickel layer is welded to the fourth bonding pad.

Further, the plug-in connector includes a connecting portion and snap-in portions respectively provided at both ends of the connection portion, and the first circuit board is provided with snap-in slots respectively corresponding to the snap-in portions, and the connection portion. A cotter pin protrudes from a side of the second circuit board close to the second circuit board, and the cotter pin is inserted into the second circuit board.

Further, the clamping part includes a first clamping strip vertically connected to one end of the connecting part and a second clamping strip connected to the first clamping strip. The first clamping strip and the second clamping strip have a “V”-shaped structure, and a third clamping strip protrudes from the outside of the second clamping strip. The opening and closing angle between the first clamping strip and the second clamping strip occurs according to the clastic deformation of the two.

Further, a sealing gasket is provided between the connecting portion and the first circuit board.

Further, the third soldering pad is connected to pins, the second soldering pad is connected to pins, and the pins penetrate the connecting part and the sealing pad and then are inserted into the corresponding pins.

Further, the pins have a ring-shaped structure and are integrally formed with the corresponding second pads.

Further, the pins are connected as one body through injection molding parts and plugged into the first circuit board, and the pins are connected to the corresponding second pads one by one.

Further, a positioning pin protrudes from a side of the connecting portion close to the first circuit board. A positioning hole corresponding to the positioning pin is provided in the first circuit board. The positioning pin penetrates the sealing gasket and is then inserted into the sealing pad and the positioning hole.

Further, the connection between the second circuit board and the third circuit board is sealed with insulating tape.

Further, an end of the second circuit board facing away from the first circuit board is provided with an insulating pad corresponding to the plug pin.

Further, the connection point between the second circuit board and the third circuit board is sealed by an insulating shell.

Further, the insulating shell is integrally molded by injection molding to cover the surface of the connection between the second circuit board and the third circuit board, and is provided with a plug-in window.

Further, the connection between the second circuit board and the third circuit board is sealed by a heat shrink sleeve.

Further, the heat shrink sleeve is a PET heat shrink sleeve.

Further, the plug connector is replaced by a metal clip assembly. The metal clip assembly is composed of two first metal clips that are independent of each other and arranged correspondingly. The first metal clip includes a first metal clip that is perpendicular to the first circuit board. Clamping piece, the bottom end of the first clamping piece is connected to a second clamping piece, the first clamping piece and the second clamping piece form a “V”-shaped structure, and the opening of the “V”-shaped structure. The closing angle changes with its elastic deformation. The top end of the second clamping piece is provided with a bending portion; the top end of the first clamping piece is bent and connected to a third clamping piece. The third clamping piece The main part is perpendicular to the first circuit board, and a plurality of “L”-shaped plug teeth protrude from the bottom end of the third clamping piece. The horizontal part of the “L”-shaped plug teeth is connected to the third clamping piece. Bottom end of film.

Compared with the prior art, the advantage of the present invention is that the connector has a simple structure, and the second circuit board and the third circuit board as a whole can be detached and assembled on the first circuit board through the plug connector, making it easy to disassemble and replace.

### BRIEF DESCRIPTION OF THE FIGURES

In order to explain the embodiments of the present invention more clearly, the drawings needed to be used in the description of the embodiments will be briefly introduced below. Obviously, the drawings in the following description are only some embodiments recorded in the present invention. For those of ordinary skill in the art, other drawings can be obtained based on these drawings without exerting creative efforts.

FIG. 1 shows a schematic structural diagram of a connector in a specific embodiment of the present invention.

FIG. 2 shows a schematic diagram of the connection between pins and pins in a specific embodiment of the present invention.

FIG. 3 shows a schematic diagram of the welding of the fourth and fifth pads in a specific embodiment of the present invention.

FIG. 4 is a schematic structural diagram of a plug connector in a specific embodiment of the present invention.

FIG. 5 is a schematic structural diagram of a sealing gasket in a specific embodiment of the present invention.

FIG. 6 is a schematic structural diagram of an insulating pad in a specific embodiment of the present invention.

FIG. 7 is a schematic structural diagram of a connector in another specific embodiment of the present invention.

FIG. 8 is a schematic cross-sectional view of a connector in another specific embodiment of the present invention.

FIG. 9 is an exploded schematic diagram of the pins and the first circuit board in another specific embodiment of the present invention.

FIG. 10 is an exploded schematic diagram of the pins and the second circuit board in another specific embodiment of the present invention.

FIG. 11 is a schematic structural diagram of an insulating housing in another specific embodiment of the present invention.

FIG. 12 is a schematic structural diagram of a connector in another specific embodiment of the present invention.

FIG. 13 shows a schematic structural diagram of the first metal clip in another specific embodiment of the present invention.

### DESCRIPTION OF EMBODIMENTS

The technical solutions in the embodiments of the present invention will be described in detail below with reference to the accompanying drawings in the embodiments of the present invention. Obviously, the described embodiments are only some, not all, of the embodiments of the present invention. Based on the embodiments of the present invention, all other embodiments obtained by those of ordinary skill in the art without any creative work fall within the scope of protection of the present invention.

In the description of the present invention, it should be noted that the “or” includes the relationship of “and”. The “and” is equivalent to the Boolean logical operator “and”, the “or” is equivalent to the Boolean logical operator “or”, and “and” is a subset of “or”.

It will be understood that, although the terms “first,” “second,” etc. may be used herein to describe various elements, these elements should not be limited by these terms. These terms are only used to distinguish one element from another element. Thus, a first element could be termed a second element without departing from the teachings of the inventive concept.

In the present invention, the terms “comprises”, “comprising” or “includes” indicate that various ingredients can be used together in the mixture or composition of the present invention. Thus, the term “consisting essentially of” is encompassed by the term “contains,” “includes,” or “including.”

Unless otherwise clearly stated and limited, the terms “connect”, “connected” and “connecting” in the present invention should be understood in a broad sense. For example, it can be a fixed connection, or it can be connected through an intermediary medium, or it can be two elements. Internal connectivity or interaction between two components. For those of ordinary skill in the art, the specific meanings of the above terms in this application can be understood according to specific circumstances.

For example, if an element (or component) is referred to as being on, coupled to, or connected to another element, then the one element can be directly formed on, coupled to, or connected to the other element. Either connected to them, or there can be one or more intervening elements between them. On the contrary, if the expressions “directly on,” “directly coupled to,” and “directly connected to” are used, there are no intervening element. Other words used to describe the relationship between elements should be interpreted similarly, such as “between” and “directly between,” “attached” and “directly attached”, “adjacent” and “directly adjacent” and so on.

In addition, it should be noted that the words “front”, “back”, “left”, “right”, “upper” and “lower” used in the following description refer to the directions in the drawings. The words “inside” and “outside” are used to refer to directions toward or away from, respectively, the geometric center of a particular component. It will be understood that, herein, these terms are used to describe the relationship of one element, layer or region to another element, layer or region as illustrated in the figures. These terms are intended to encompass other orientations of the device in addition to the orientation depicted in the figures.

Other aspects of the invention will be apparent to those skilled in the art from the disclosure herein.

In order to explain the embodiments of the present invention more clearly, the specific implementation modes of the present invention will be described below with reference to the accompanying drawings. Obviously, the drawings in the following description are only some embodiments of the present invention. For those of ordinary skill in the art, without exerting creative efforts, other drawings can also be obtained based on these drawings, and obtain other embodiments.

It should also be noted that the diagrams provided in the following embodiments are only schematically illustrating the basic concept of the present application. The drawings only show the components related to the present application and are not based on the number, shape and number of components during actual implementation. Dimension drawing, in actual implementation, the type, quantity and proportion of each component can be arbitrarily changed, and the component layout type may also be more complex. For example, the thicknesses of elements in the drawings may be exaggerated for clarity.

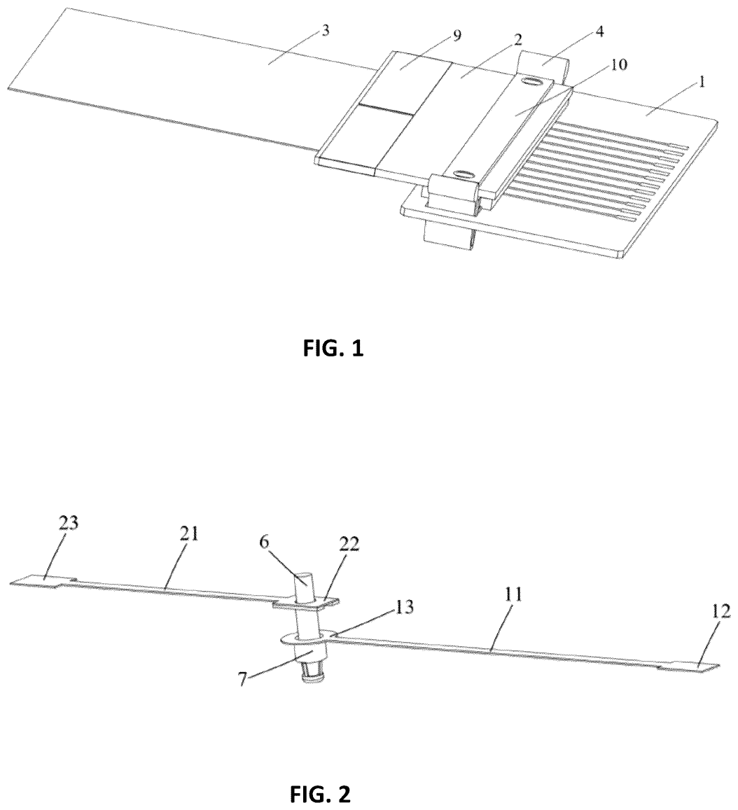

As shown in FIGS. 1-11, the present invention provides a connector, which includes a first circuit board 1 and a connector removably connected to the first circuit board 1. The connector includes a second circuit board. 2 and a third circuit board 3. One end of the second circuit board 2 is detachably connected to the first circuit board 1 through a connector 4, and the other end is electrically connected to one end of the third circuit board 3, the third circuit board 3 is a flexible circuit board, and the third circuit board 3 is electrically connected to the first circuit board 1 through the second circuit board 2.

In this technical solution, the other end of the third circuit board 3 is connected to external electrical devices through a connector or other existing connection structure.

In this technical solution, the first circuit board 1 and the second circuit board 2 are printed circuit boards (Printed Circuit Board, PCB), and the third circuit board 3 is a flexible printed circuit (FPC), so the second circuit board 2 and the third circuit board 3 constitute the connecting piece as a whole, and are detachably connected to the first circuit board 1 through the plug connector 4, thereby realizing the connection between the printed circuit board and the flexible circuit board. Detachable installation, convenient and quick.

For example, as shown in FIGS. 1-3, a number of first circuits 11 are provided in the first circuit board 1, and first soldering pads 12 and second soldering pads 13 are respectively provided at both ends of the first circuits 11. A plurality of second circuits 21 are provided in the second circuit board 2. The third soldering pads 22 and the fourth soldering pads 23 are respectively provided at both ends of the second circuits 21. The third circuit board 3 is provided with a fifth soldering pad at one end close to the second circuit board 2. Pad 31, wherein the second pad 13 is electrically connected to the third pad 22, and the fourth pad 23 is electrically connected to the fifth pad 31.

In this technical solution, the first circuit 11 and the second circuit 21 are respectively formed in the corresponding first circuit board 1 and the second circuit board 2 through conventional processes such as silk screen and green oil, and the first circuit 11. The two ends of the second line 21 are provided with the first pad 12 and the second pad 13 exposed on the first circuit board 1, and the two ends of the second line 21 are provided with the third pad 22 and the fourth exposed on the second circuit board 2 of pad 23.

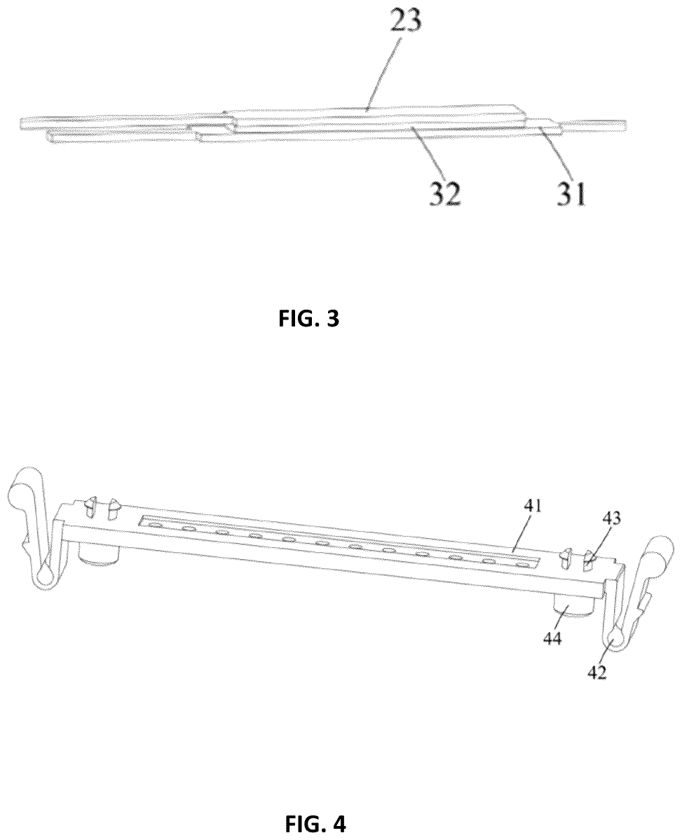

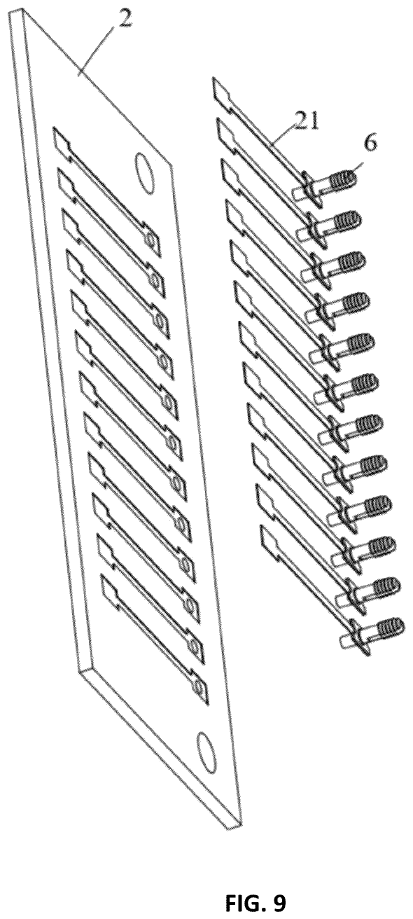

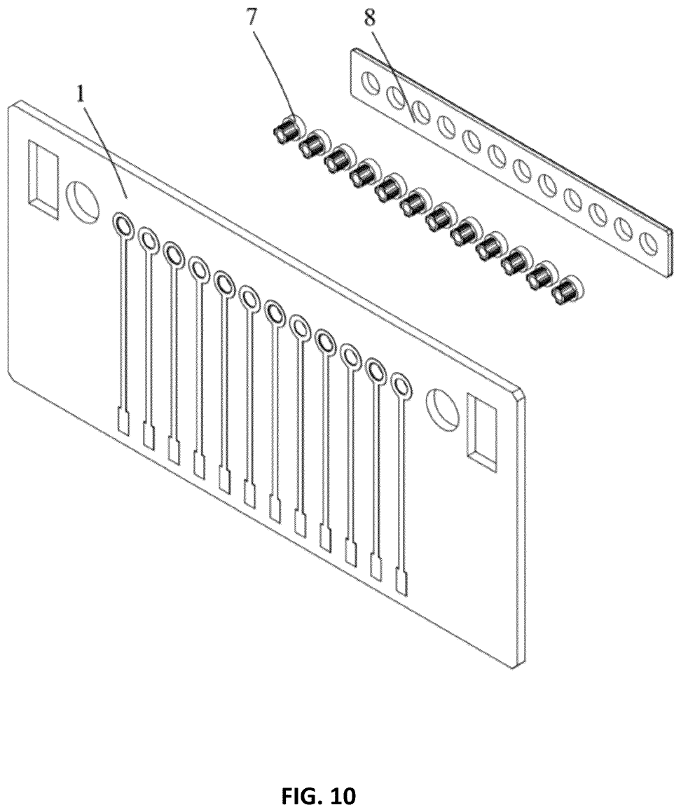

For example, as shown in FIGS. 3 and 8, the third circuit board 3 includes a number of conductive lines and protective films laminated on both sides of the conductive lines. The protective film is processed and formed near one end of the second circuit board 2. There are escape holes corresponding to the conductive lines, and the conductive lines exposed in the escape holes form the fifth pad 31.

In this technical solution, protective films on both sides of the conductive line are placed on both sides of the conductive line through conventional methods such as hot pressing to insulate and encapsulate the conductive line. A number of avoidance holes are provided in the protective film to expose the ends of the conductive line to form for the fifth pad, in order to ensure the stability of the fixation between the protective film and the fifth pad 31 and the reliability of the subsequent conductive connection, the width of the conductive line is increased at the avoidance hole, and the end continues to extend outward for a certain length.

Exemplarily, the conductive lines are made of metal, preferably copper or aluminum.

In this technical solution, the conductive wires are processed by laser cutting and other processes from conductive metal plates, and are then placed in protective films on both sides.

For example, as shown in FIG. 3, a nickel layer 32 is provided on a side surface of the fifth bonding pad 31 close to the fourth bonding pad 23, and the nickel layer 32 is welded to the fourth bonding pad 23.

In this technical solution, the third circuit board is an aluminum-based flexible circuit board, and the conductive lines are cut and shaped by aluminum foil. Since the surface of metallic aluminum is prone to form an oxide layer, and the presence of the oxide layer will affect the fourth pad 23 and the fifth contact between the pads 31 (that is, between the contact part and the conductive part) is conductive, so a nickel-plated connecting aluminum sheet or nickel-plated or sintered aluminum plate is welded to the side of the fifth pad 31 close to the fourth pad 23. A layer of metallic nickel, so that the aluminum fifth pad 31 can be directly connected to the copper fourth pad 23 through laser welding to solve the above technical problems; in addition, because the fifth pad 31 is exposed in the escape hole the conductive circuit is formed, that is, the surface of the fifth soldering pad 31 is lower than the surface of the protective film. Therefore, when the third circuit board 3 is attached to the second circuit board 2, there is a gap between the fifth soldering pad and the fourth soldering pad. The gap is filled by the arrangement of the nickel layer, so that the fifth bonding pad 31 and the fourth bonding pad 23 are in direct contact, thereby improving the stability of welding.

Illustratively, as shown in FIGS. 1 and 4, the plug connector 4 includes a connecting portion 41 and snap portions 42 respectively provided at both ends of the connecting portion 41. The first circuit board 1 is provided with respective snap pin 43 protrudes from a side of the connection portion 41 close to the second circuit board 2 in the snap slot corresponding to the snap portion 42, and the split pin 43 is inserted into the second circuit board 2.

In this technical solution, the connecting part 41 connects the two clamping parts 42 into one body to ensure the overall strength of the connector 4. During the board manufacturing process of the first circuit board 1, a clamping slot is preset. The clamping part 42 includes a first clamping strip vertically connected to one end of the connecting part 41 and a second clamping strip connected to the first clamping strip. The first clamping strip and the second clamping strip form a “V”-shaped structure, the opening and closing angle of the “V”-shaped structure changes with its elastic deformation, and a third snap-in strip protrudes from the outside of the second snap-in strip; when installing, directly insert the snap-in part into the corresponding clamping groove squeezes the second clamping strip until the top surface of the third clamping strip is clamped to the bottom surface of the first circuit board 1. The third clamping strip can prevent the clamping part from falling off the card. slot; when disassembling, manually squeeze the second clamping strip to one side of the first clamping strip until the distance between the outermost sides of the first clamping strip and the third clamping strip is less than the width of the clamping slot, and then pull out the clamping portion 42; during the manufacturing process of the second circuit board 2, an insertion hole corresponding to the cotter pin 43 is preset. The cotter pin 43 is a cylindrical structure with an open slot in the middle, and the cotter pin top end 43 protrudes along its circumferential outer side with an arc-shaped fourth snap-in strip. When the split pin 43 is inserted into the insertion hole, its two sides are squeezed and tilted toward the inside of the slot. After insertion, the fourth snap-in strip is reset. The connecting strip is clamped on the surface of the second circuit board 2 to prevent the plug connector 4 from falling off the second circuit board 2; the plug connector can also use the existing structure to realize the connection between the second circuit board 2 and the first circuit board 1. Just disassemble and assemble the space.

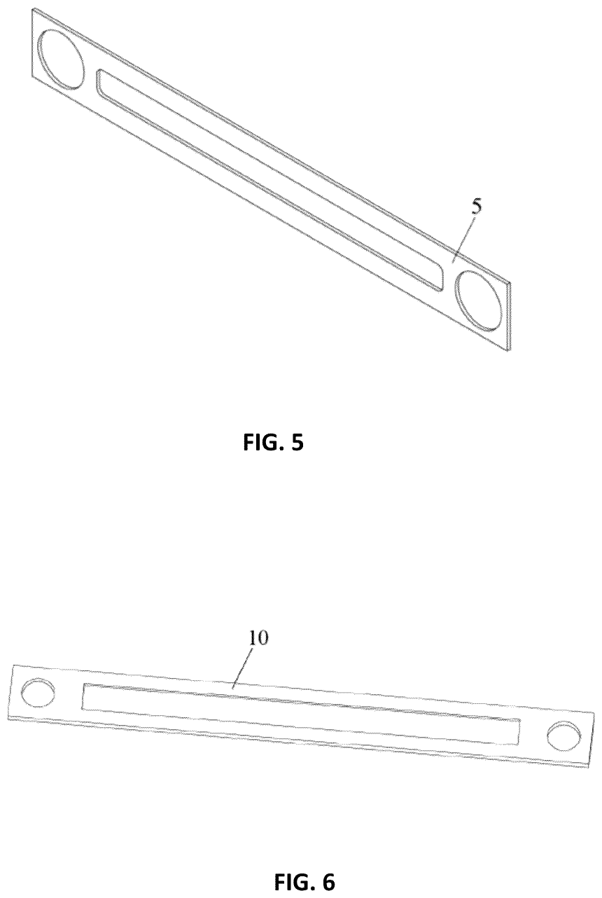

For example, as shown in FIGS. 5 and 8, a sealing gasket 5 is provided between the connecting portion 41 and the first circuit board 1.

In this technical solution, the sealing gasket 5 is made of high-temperature resistant insulating material and is fixed to the first circuit board 1 and/or the connecting portion 41 by gluing or other means. A connection window is provided in the sealing gasket 5 to avoid interference with the second circuit board 1. For the conduction between the bonding pad 13 and the third bonding pad 22, the sealing gasket 5 seals the second bonding pad 13, the third bonding pad 22 and their connection to avoid being affected by external impurities and the like.

For example, as shown in FIG. 8, the bottom of the connecting portion 41 is concavely provided with a positioning groove corresponding to the sealing gasket. The sealing gasket 5 is fixed in the positioning groove through glue, which facilitates the quick positioning and installation of the sealing gasket 5.

For example, as shown in FIG. 2, the third soldering pad 22 is connected to pins 6, and the second soldering pad 13 is connected to pins 7. The pins 6 penetrate the connecting part 41 and the sealing pad 5 and then are plugged into the corresponding pins 7.

In this technical solution, the pin 6 has a cylindrical structure, the top of which penetrates the third soldering pad 22 and the second circuit board 2, and a sixth soldering pad protrudes close to the third soldering pad 22, and is soldered through soldering, etc. The way is fixed to the third pad 22. The top of the connecting part 41 is provided with a relief groove 44 corresponding to the sixth pad to ensure that the second circuit board 2 is completely attached to the connecting part 41. The bottom end of the pin 7 is provided with a number of the card pin contacts pin 7 through the stress of its own deformation, thereby achieving a conductive connection between the third pad 22 and the second pad 13. Pin 7 and pin 6 can also use existing pins. It is sufficient that the third pad 22 and the second pad 13 can achieve plug-in conductive connection with other structures.

For example, as shown in FIGS. 9-10, the bottom end of the pin 6 is provided with a deformation groove, and a number of annular protrusions protrude from the lateral circumferential surface of the pin 6. After the pin 6 is inserted into the pin 7, the annular protrusion is in contact with the inner wall of the pin 7 to achieve a conductive connection between the third pad 22 and the second pad 13.

For example, as shown in FIG. 2, the pin 7 has a ring structure and is integrally formed with the corresponding second pad 13.

In this technical solution, the second bonding pad 13 has an annular structure, and a through hole corresponding to the second bonding pad 13 is formed in the first circuit board 1. During the board manufacturing process, copper is immersed in the through hole, etc. Craft to form pin 7.

For example, as shown in FIG. 10, the pins 7 are integrated with the injection molded part 8 and plugged into the first circuit board 1, and the pins 7 are connected to the corresponding second pads 13 one by one.

In this technical solution, the pin 7 is an independently arranged T-shaped structure, including an integrally formed fixing seat and a socket. The center of the socket is provided with a blind hole corresponding to the pin 6, and a number of protrusions protrude from the outer wall. After the socket is inserted into the through hole of the first circuit board, the convex rib contacts the second pad 13 and is connected. In order to ensure the conduction effect, it can be reinforced by soldering and other methods; the fixed seats of pin 7 are buried in rows. In the injection molded part 8, during installation, the plurality of pins 7 can be regarded as one part and can be installed at one time. The process of covering the pins in the injection molded part is an existing technology and will not be described again here.

For example, as shown in FIG. 4, a positioning pin protrudes from the side of the connecting portion 41 close to the first circuit board 1, and a positioning hole corresponding to the positioning pin is provided in the first circuit board 1, and the positioning pin penetrates the scaling gasket, then plug into the positioning hole.

In this technical solution, after the plug connector 4 is inserted into the plug slot of the first circuit board 1, the positioning pins are inserted into the corresponding positioning holes. The cooperation between the positioning pins and the positioning holes limits the connection between the plug connector 4 and the first circuit board 1. Movement along the radial direction of the positioning pin, and the clamping portion limits the axial movement along the positioning pin, completely fixing the connector 4 and the first circuit board 1, that is, the first circuit board 1 and the second circuit board 2 are completely fix it to avoid damage to pins 6, etc. due to shaking.

For example, as shown in FIG. 1, the connection between the second circuit board 2 and the third circuit board 3 is sealed by an insulating tape 9.

In this technical solution, after the fourth pad 23 and the fifth pad 31 are welded, the insulating tape 9 is wrapped around the connection between the second circuit board 2 and the third circuit board 3 to improve sealing.

For example, as shown in FIGS. 1 and 5, an insulating pad 10 corresponding to the pin 6 is provided on one end of the second circuit board 2 away from the first circuit board 1.

In this technical solution, an insulating pad 10 made of FR4 resin is pressed onto the surface of the second circuit board 2 by gluing or other methods, and is provided with a relief hole corresponding to the cotter pin 43 and a corresponding hole to the pin 6. The avoidance groove insulates the top of pin 6 to avoid leakage caused by external influences.

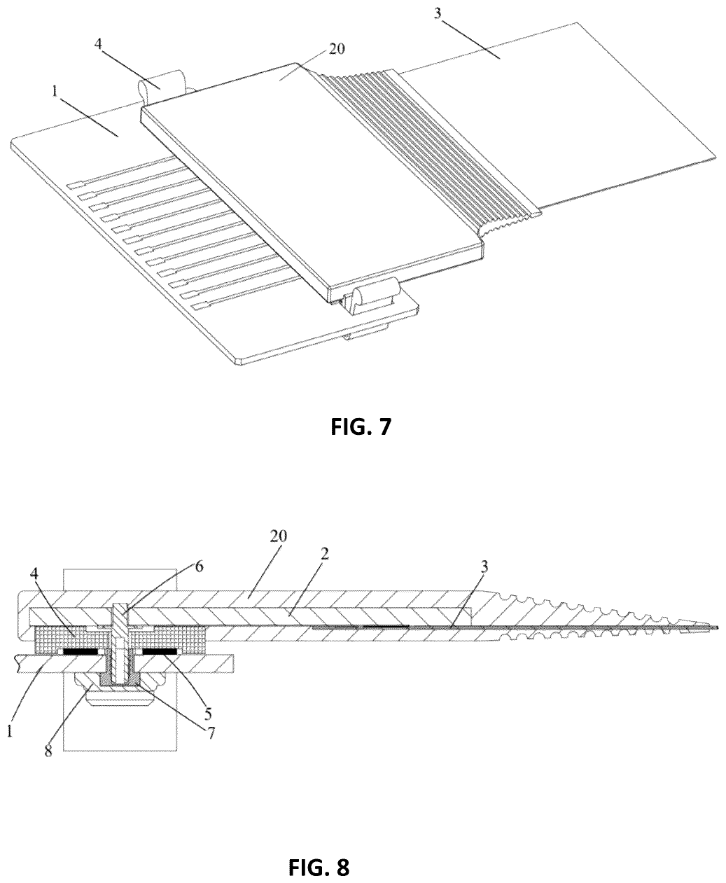

For example, as shown in FIGS. 6 and 7, the connection point between the second circuit board 2 and the third circuit board 3 is sealed by an insulating housing 20.

In this technical solution, after the fourth pad 23 and the fifth pad 31 are welded, the insulating case 20 is wrapped at the connection between the second circuit board 2 and the third circuit board 3 by injection molding or other methods, and the top surface of the second circuit board 2 is completely covered, and the insulating case 20 serves as both an insulating tape and an insulating pad. It can also enhance the strength of the connection between the second circuit board 2 and the third circuit board 3 and protect the second circuit board 2. The third circuit board is to avoid damage caused by bending. The insulating shell is provided with a number of bending grooves on the surface of the third circuit board 3 to allow bending and facilitate wiring layout.

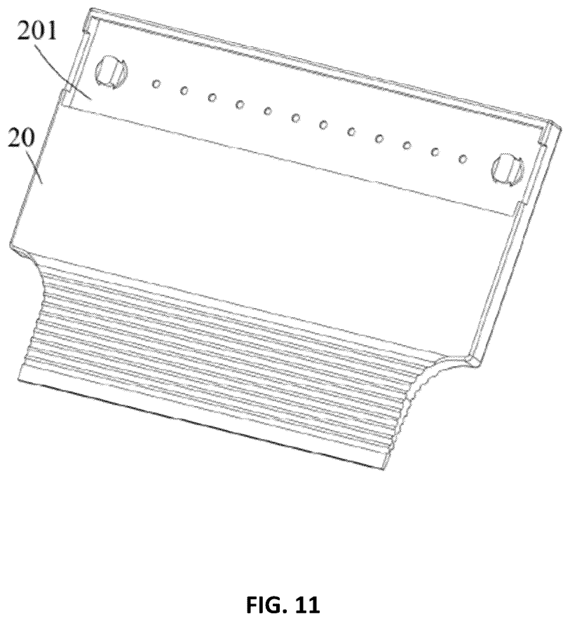

In this technical solution, as shown in FIG. 11, the insulating housing 20 is integrally formed on the surface of the connection between the second circuit board 2 and the third circuit board 3 through injection molding, and is provided with a plug-in window 201.

In this technical solution, after the plug connector 4 is fixed on the second circuit board 2, the insulating shell 20 is then wrapped at the connection point between the second circuit board 2 and the third circuit board 3 through injection molding, and is placed on the plug connector 4 form a plug-in window to avoid interference between the plug-in part and the plug-in slot, between the positioning pin and the positioning hole, and between the pin 6 and the pin 7, and connect the plug connector 4 and the second circuit board 2 seal between.

For example, the connection between the second circuit board 2 and the third circuit board 3 is sealed by a heat shrink tube.

In this technical solution, after the fourth pad 23 and the fifth pad 31 are welded, the heat shrink sleeve is wrapped at the connection between the second circuit board 2 and the third circuit board 3, and after the coating is completed, the heat shrink sleeve is heated to shrink the heat shrink sleeve to achieve insulation protection. The heat shrinkable sleeve not only has the functions of heat shrinkage and insulation protection, but also has the functions of soft flame retardant and anti-corrosion.

In this technical solution, the heat shrink sleeve may be a PET (Polyethylene Glycol Terephthalate, polyethylene terephthalate) heat shrink sleeve.

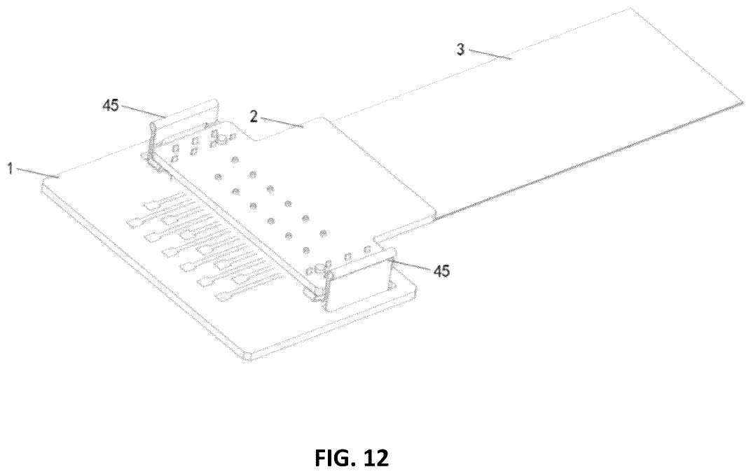

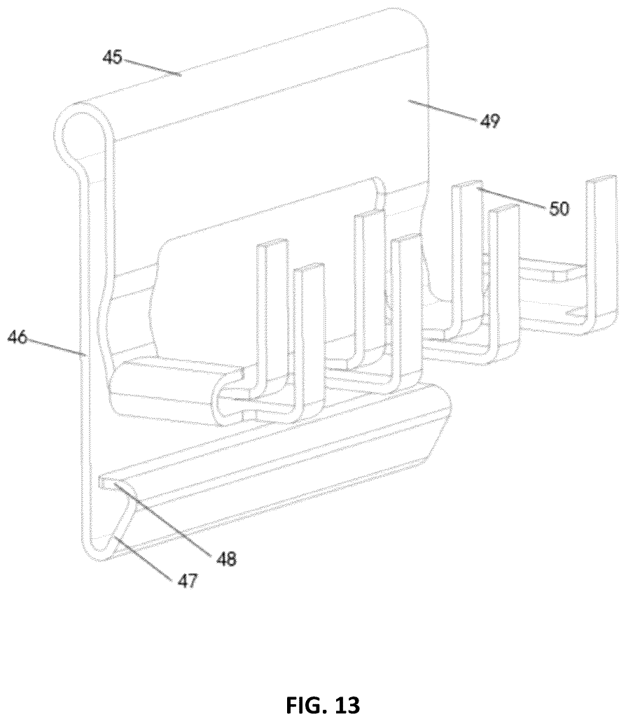

For example, as shown in FIGS. 12 and 13, the plug connector 4 can also be entirely replaced with a metal clip assembly to achieve fixed connection between the first circuit board 1 and the second circuit board 2. The metal clip assembly is composed of two first metal clips 45 that are independent of each other and arranged correspondingly. The first metal clip 45 includes a first clamping piece 46 perpendicular to the first circuit board 1. A second clamping piece 47 is connected to the bottom end of the piece 46. The first clamping piece 46 and the second clamping piece 47 form a “V”-shaped structure. The opening and closing angle of the “V”-shaped structure changes with its elastic deformation. As a change, the top end of the second clamping piece 47 is provided with a bending portion 48; the top end of the first clamping piece 46 is bent and connected to a third clamping piece 49, and the main body of the third clamping piece 49. The third clamping piece 49 is partially perpendicular to the first circuit board 1. A plurality of “L”-shaped insertion teeth 50 protrude from the bottom end of the third clamping piece 49. The horizontal portion of the “L”-shaped insertion teeth 50 is connected to the bottom of the third clamping piece 49, odd-numbered “L”-shaped plugging teeth and even-numbered “L”-shaped plugging teeth among the plurality of “L”-shaped plugging teeth are staggered.

In this technical solution, two clamping grooves are symmetrically arranged in the first circuit board 1, and the direction of the connection between the two clamping grooves is in line with the first circuit board 1, the second circuit board 2, and the third circuit board. The direction of electrical connections on board 3 is vertical. Two clamping hole arrays are symmetrically arranged in the second circuit board 2, and the two clamping hole arrays respectively correspond to the vertical portions of the “L” shaped insertion teeth of the two first metal clips 45. During installation, insert the bottom ends of the two first metal clips 45 into the corresponding clamping grooves, and the clamping grooves press the second clamping piece 47 until the bent portion 48 at the top of the second clamping piece 47 passes through and support the clamping groove; at this time, insert the two clamping hole arrays of the second circuit board 2 into the “L” shaped insertion teeth of the two first metal clips 45, and connect them to the first circuit board 1. An insulation layer is provided in the gap between the second circuit boards 2 to realize the coordinated installation between the first circuit board 1 and the second circuit board 2 and to ensure insulation and scaling.

In this technical solution, the second clamping piece 47, the first clamping piece 46, and the third clamping piece 49 that are connected in sequence can be made by an integral molding process.

In this technical solution, the bending portion 48 is a horizontal bending portion.

To sum up, the connector has a simple structure, and the second circuit board 2 and the third circuit board 3 as a whole can be detached and assembled on the first circuit board through the plug connector, which is convenient for disassembly and replacement.

Based on this application, those skilled in the art will appreciate that one aspect described herein can be implemented independently of any other aspect, and that two or more of these aspects can be combined in various ways. For example, apparatuses may be implemented and/or methods practiced using any of the numbers and aspects set forth herein. Additionally, such apparatus may be implemented and/or methods practiced using other structures and/or functionality in addition to one or more of the aspects set forth herein.

Those skilled in the art know that in addition to implementing the system and its various devices, modules, and units provided by the present invention in the form of pure computer-readable program codes, the system and its various devices provided by the present invention can be completely implemented by logically programming the method steps, modules, and units implement the same functions in the form of logic gates, switches, application-specific integrated circuits, programmable logic controllers, and embedded microcontrollers. Therefore, the system and its various devices, modules and units provided by the present invention can be regarded as a kind of hardware component, and the devices, modules and units included in it for realizing various functions can also be regarded as hardware components. The structure; the devices, modules, and units used to implement various functions can also be regarded as either software modules for implementing methods or structures within hardware components.

It should be noted that the above embodiments can be freely combined as needed. The above are only the preferred embodiments of the present invention. It should be pointed out that those of ordinary skill in the art can also make several improvements and modifications without departing from the principles of the present invention. These improvements and modifications can also be made and should be regarded as the protection scope of the present invention.

All documents mentioned in this application are incorporated by reference in this application to the same extent as if each individual document was individually incorporated by reference. In addition, it should be understood that after reading the above content of the present invention, those skilled in the art can make various changes or modifications to the present invention, and these equivalent forms also fall within the scope defined by the appended claims of this application.

What is claimed is:

1. A connector, characterized in that it includes a first circuit board and a connector detachably connected to the first circuit board, the connector includes a second circuit board and a third circuit board, and the third circuit board, one end of the second circuit board is detachably connected to the first circuit board through a plug connector, and the other end is electrically connected to one end of the third circuit board, the third circuit board is a flexible circuit board, and the third circuit board is electrically connected to the first circuit board through the second circuit board.

2. The connector according to claim 1, characterized in that: a plurality of first circuits are provided in the first circuit board, and first and second soldering pads are respectively provided at both ends of the first circuits, a plurality of second circuits are provided in the second circuit board, third and fourth soldering pads are respectively provided at both ends of the second circuit board, the third circuit board is provided close to one end of the second circuit board, a fifth bonding pad, wherein the second bonding pad is electrically connected to the third bonding pad, and the fourth bonding pad is electrically connected to the fifth bonding pad.

3. The connector according to claim 2, wherein the third circuit board includes a plurality of conductive lines and protective films laminated on both sides of the conductive lines, and the protective film is close to the second circuit board, one end is processed with an escape hole corresponding to the conductive circuit, and the conductive circuit exposed in the escape hole forms the fifth bonding pad.

4. The connector according to claim 3, wherein the conductive wire is made of metal.

5. The connector according to claim 4, wherein the conductive wire is made of copper or aluminum.

6. The connector according to claim 3, wherein a nickel layer is provided on a surface of the fifth solder pad close to the fourth solder pad, and the nickel layer is welded to the fourth solder pad or plate.

7. The connector according to claim 2, characterized in that: the plug connector includes a connecting portion and snap-in portions respectively provided at both ends of the connecting portion, and the first circuit board is provided with a connecting portion respectively connected to the connecting portion, a cotter pin protrudes from the coupling groove corresponding to the coupling portion, and is protruding from a side of the connecting portion close to the second circuit board, and the cotter pin is inserted into the second circuit board.

8. The connector according to claim 7, wherein the latching portion includes a first latching strip vertically connected to one end of the connecting portion and a second latching strip connected to the first latching strip, a “V”-shaped structure is formed between the first clamping strip and the second clamping strip, and a third clamping strip protrudes from the outside of the second clamping strip, the first clamping strip and the second clamping strip, the opening and closing angle changes according to the elastic deformation of the two.

9. The connector according to claim 7, wherein a sealing gasket is provided between the connecting portion and the first circuit board.

10. The connector according to claim 9, wherein the third soldering pad is connected to pins, the second soldering pad is connected to pins, and the pins penetrate the connecting part and the sealing pad, and plug into the corresponding pins.

11. The connector according to claim 10, wherein the pins have an annular structure and are integrally formed with the corresponding second pads.

12. The connector according to claim 10, characterized in that: the pins are connected as a whole through injection molding parts and plugged into the first circuit board, and the pins are connected to the corresponding second pads one by one.

13. The connector according to claim 9, wherein a positioning pin protrudes from a side of the connecting portion close to the first circuit board, and a positioning hole corresponding to the positioning pin is provided in the first circuit board, the positioning pin penetrates the sealing gasket and is inserted into the positioning hole.

14. The connector according to claim 1, wherein the connection between the second circuit board and the third circuit board is sealed by an insulating tape.

15. The connector according to claim 14, wherein an end of the second circuit board facing away from the first circuit board is provided with an insulating pad corresponding to the plug pin.

16. The connector according to claim 1, wherein the connection between the second circuit board and the third circuit board is sealed by an insulating shell.

17. The connector according to claim 16, wherein the insulating shell is integrally formed by injection molding to cover the surface of the connection between the second circuit board and the third circuit board, and is provided with a plug-in window.

18. The connector according to claim 1, wherein the connection between the second circuit board and the third circuit board is sealed by a heat shrink sleeve.

19. The connector according to claim 18, wherein the heat shrink sleeve is a PET heat shrink sleeve.

20. The connector according to claim 1, wherein the plug connector is replaced by a metal clip assembly, and the metal clip assembly is composed of two first metal clips that are independent of each other and arranged correspondingly, and the third metal clip is a metal clip includes a first clamping piece perpendicular to the first circuit board, a second clamping piece is connected to the bottom end of the first clamping piece, there is a gap between the first clamping piece and the second clamping piece. “V”-shaped structure, the opening and closing angle of the “V”-shaped structure changes with its elastic deformation, and the top end of the second clamping piece is provided with a bending portion, the top end of the first clamping piece is bent and connected to a third clamping piece, the main part of the third clamping piece is perpendicular to the first circuit board, the bottom end of the third clamping piece protrudes a plurality of “L” shaped splicing teeth, the horizontal part of the “L” shaped splicing teeth is connected to the bottom end of the third clamping piece.
